(19) United States
(12) Patent Application Publication
(10) Pub. No.: US 2010/0187937 A1
(43) Pub. Date: Jul. 29, 2010

(54) ELECTRIC MACHINE HAVING CONDUCTOR LOOPS SITUATED IN SLOTS, AND METHOD FOR OPERATING THE ELECTRIC MACHINE

(76) Inventors: Thomas Faber, Woerth-Maximiliansau (DE); Gerald Roos, Sasbachried (DE)

Correspondence Address: KENYON & KENYON LLP, ONE BROADWAY, NEW YORK, NY, 10004, US

(21) Appl. No.: 12/452,891

(22) PCT Filed: Jun. 6, 2008
(86) PCT No.: PCT/EP2008/057082

§ 371 Date: Apr. 6, 2010

(30) Foreign Application Priority Data
Aug. 2, 2007 (DE) 10 2007 036 253.8

(51) Int. Cl. H02K 3/28

(52) U.S. Cl. 310/195

(57) ABSTRACT

An electric machine, as well as a method for operating such a machine, particularly for motorically moving movable parts in a motor vehicle, having a stator and a rotor, slots being developed on the rotor, in which individual conductor loops of electric coils are situated, which are contacted to commutator segments of a commutator and to an evaluating unit, which ascertains rotational speed data from the ripple of a motor current signal. The number of individual conductor loops of the coils is selected in such a way that the sequence of the number of the conductor loops in the order of their commutation approximately represents a sine function.

### BACKGROUND INFORMATION

A commutation device of a DC motor is described in European Patent No. EP 0 917 755, in which brushes lie against a contact area of the segments of a commutator. An electronic circuit records the frequency of the ripple of the motor current, in this context, in order to determine from this a measure of the rotational speed of the electric motor. To gain reliable rotational speed information, the edges of the commutator segments are at a certain angle to the longitudinal axis of the commutator and to the edges of the brushes. Such a commutator is very costly to produce, and offers no possibility of generating a frequency of the ripple that is smaller than the slot-ripple frequency.

In such electric motors, the alternating component of the current signal is evaluated for the rotational speed detection. The ripple of this signal is generated by various causes. A large component of the ripple has the number of the slots of the commutator. In the current signal, one is able to detect the slot number and its multiples. In this context, the order of the smallest common multiple of the slot number and the magnetic pole number mostly occurs in a dominating manner. This ripple is caused in the lower rotational speed range (smaller rotational speeds) and under great load by the variation of the armature resistance over the commutation. Near the idling speed and at low current, the ripple is generated by the variation of the induced voltage, caused by the coil windings in the magnetic field. At medium motor load, the ripple in the curve over time of the current signal is caused by both effects. The two effects may be phase-shifted with respect to each other, and may be eliminated at various operational points, so that the slot order and its multiples in the current characteristic clearly vary over the characteristics curve of the motor, and may even disappear. Furthermore, current ripples appear in the current characteristic having orders less than that of the slot order. These are mostly multiples of the magnetic poles. These orders of the current ripple are caused by undesired tolerances in the symmetry of the magnetic circuit, such as position tolerances or material tolerances of the magnets. Because of their irregularity, these orders in the current curve over time prevent a reliable evaluation for determining the motor rotational speed signal. For the evaluation of the slot order of the current ripples, the ripple further has to exceed a certain height of amplitude so that the signals are able to be evaluated. In addition, the amplitudes of the orders vary over different operating points, which also makes evaluation more difficult. In motors having a larger slot number, the dominating order in the current characteristic of the current ripples is so high, because of the large number of slots and magnetic poles, that evaluation electronics having a higher scanning frequency becomes required for determining the rotational speed of the motor. This means a greater effort and higher costs, since the microcontrollers have to be faster and better.

### SUMMARY OF THE INVENTION

By contrast, the electric machine according to the present invention, as well as the method according to the present invention for operating the same, have the advantage that the number of conductor loops in the slots of the rotor is varied in such a way that the number of conductor loops of coils commutated one after the other yields a sine curve as a first approximation. Such a sinusoidal change in the number of conductor loops over the sequence in time of the commutation generates additional ripple in the motor current signal, whose frequency corresponds to the product of the pole number, the number of periods of the sine function per commutating phase and the rotational frequency of the electric machine. This causes an additional ripple in the current characteristic to be produced, which is less in frequency than the slot frequency that is produced by the number of commutator segments. These additionally generated current peaks have an approximately constant amplitude, independently of the operational point of the electric machine and the amount of the load current. This is why this superposed current ripple signal is able very favorably to be evaluated, in order to ascertain information about the rotational speed, or the period duration of the rotor revolution. Because of the sinusoidal change of the conductor number over the commutation cycle, interferences of higher orders of the additional current ripple signal are largely able to be eliminated. Therefore, noise excitations of the electric machine, caused by the current ripple, may be greatly reduced, and so a relatively more quiet run may be achieved for convenience drives, in spite of the torque ripple.

It has proven to be particularly advantageous to change the number of successively commutated conductor loops by exactly one conductor loop. Because of that, as smooth as possible a sine curve of the conductor loop change may be implemented, whereby the interfering noise excitation is optimally suppressed. Optionally, even two successive coils may have the same number of conductor loops, in this context.

In one preferred embodiment, and electric DC motor has a rotor having 14 slots, into which altogether also 14 coils are fitted. This embodiment has four magnetic poles, for example, which are generated by a circumferential magnetic ring, which has a uniform pole ring subdivision of preferably 90 degrees. In this embodiment, because of the sinusoidal change of the conductor loop number via the commutator cycle, and easy-to-detect ripple signal may be generated which, for instance, has four current ripples per commutator revolution.

It is particularly favorable if the number of commutator segments, which preferably corresponds to the number of slots of the rotor, is not divisible by the number of the magnetic poles. This reduces the cogging torque of the electric machine and improves the synchronism properties of the electric machine.

It is particularly favorable to develop exactly one period of the sine function over one commutation phase, using the change in the conductor loops per coil. The amplitude of the current ripple to be detected is thereby able to be maximized, whereby the evaluation device may be simplified.

In this context, it does not matter if the number of the conductor loop slots, lying next to one another with respect to to the rotor circumference, does not continuously change sinusoidally. What is decisive is that conductor loop number changes with respect to the sequence of the successively commutated coils correspondingly to a sine function, which may deviate from the slot arrangement on the rotor by the winding scheme used.

In one preferred variant, the electric machine has coils that have between 8 and 15 individual conductor loops. If the number of conductor loops varies between 10 and 13 conductor loops, for instance, then, in a 14-slot machine a relatively smooth sine function of the conductor loop change is able to be produced by having approximately each successive commutated coil changing by exactly one conductor loop.

The variation, according to the present invention, of the number of conductor loops per coil may also be used on coils wound controsymmetrically to the rotor axis, which are developed as two symmetrical coil sections. The number of conductor loops of the two coil sections is changed, in this instance, to the same extent with respect to the nearest coil section, so that no additional radial forces are generated.

The method according to the present invention, for operating an electric machine, preferably a DC motor, has the advantage that, because of the variation, according to the present invention, of the number of conductor loops of the individual coils, a uniform current ripple having relatively constant amplitude is able to be generated, which changes only insubstantially over various working ranges of the electric machine. Because of the clearly lower frequency of this additionally generated current ripple, the scanning frequency of the rotational speed evaluation unit is able to be reduced, whereby the requirements, and thus also the costs, of the evaluation device may be reduced. The ripple signal of the motor current, generated according to the present invention, may be used particularly favorably for implementing a jamming protection function of a motorically moved part. In this context, the signal representing the rotational speed is examined by the evaluation unit for a change with time, for which the time intervals between the individual current ripples are ascertained.

### BRIEF DESCRIPTION OF THE DRAWINGS

FIG. 1 shows a first exemplary embodiment of a rotor according to the present invention, having a schematic representation of the change of the number of conductor loops.

FIG. 2 shows an additional exemplary embodiment of an electric machine together with a schematic change in the number of conductor loops.

### DETAILED DESCRIPTION

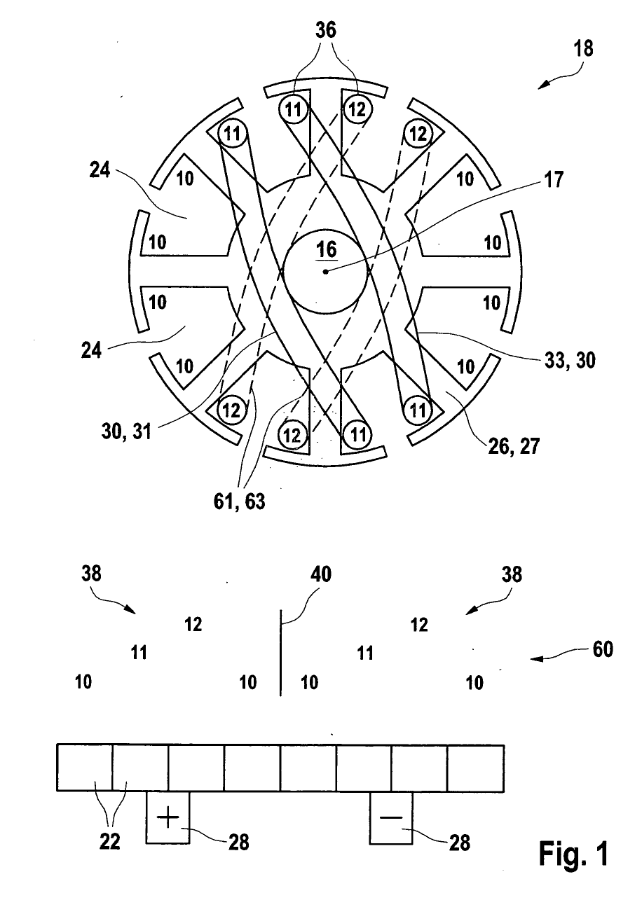

FIG. 1 shows an electric machine 12, which is developed as a DC motor 14, for example. Electric machine 12 has a rotor 18 supported on a rotor shaft 16, which has a plurality of slots 24 for accommodating electric coils 30. Slots 24 are developed, for example, in a segment stack 26, which is made up of individual lamella sheet metals 27 that are axially stacked one over another. Rotor 18 in FIG. 1 has eight slots, for example, in which altogether eight coils 30 are situated. Coils 30 are wound centrosymmetrically to a rotor axis 17, for example, using diameter winding, so that two half coils of different coils 30 are situated in each slot 24. Coils 30 are electrically connected to commutator segments 22 of a commutator 20, which has current applied to it using electric brushes 28 that are not shown in detail. Each coil 30 is made up of individual conductor loops 36, whose number is represented by the numbers stated in slots 24. Thus, for example, a specific coil 31 has eleven conductor loops 36, that are wound through opposite slots 24. In the same slot pair, a second coil 33 is situated, having eleven conductor loops 36, which in the exemplary embodiment is commutated at the same time as coil 31. The nearest coil pair 61, 63 in the circumferential direction of rotor 18 has twelve conductor loops 36 each. After that, on rotor 18 there follow four coils 30, each having 10 conductor loops 36, after which there then follows again coil pair 31, 33, each having eleven conductor loops 36.

The lower half of the illustration shows the unwound commutator segments 22 of commutator 20, the sequence of the numbers in each case reproducing the number of conductor loops 36 of coils 30 commutated one after the other. This yields an order of coils 30 commutated one after the other, each having a different number of conductor loops 36. Thus, coils 30 that are successive in one commutation phase have 10, 11, 12, 10 conductor loops 36 respectively, so that the change in the number of conductor loops approximately yields a schematically shown sine function 60. Of the eight coils 30, in this context, two are always commutated at the same time, and these two always have the same number of conductor loops 36. A commutation phase, up to which the same commutation state is reached again, in this case amounts to four successive commutation states which repeat periodically. As a function of the number of brushes 28, or rather, as a function of the number of magnetic poles corresponding to them, sinusoidal curve 60, of the change in the number of conductor loops, has one or more periods 38 over one commutator rotation. FIG. 1 shows two periods 38, which are separated by a mirror plane 40.

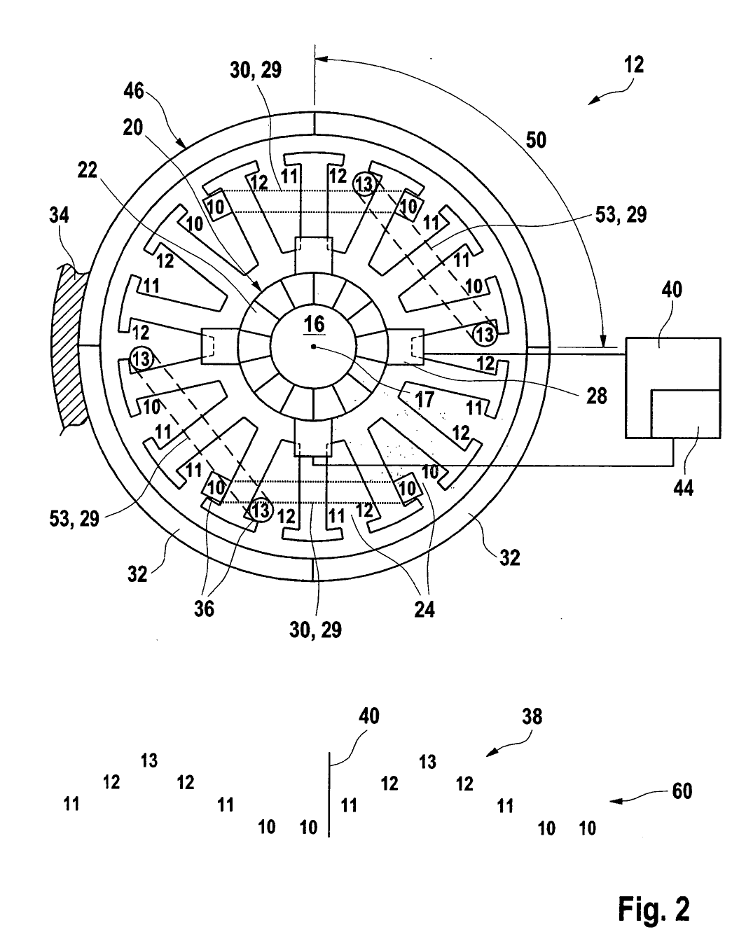

FIG. 2 shows another exemplary embodiment, in which electric machine 12 has a stator 34 having a magnetic ring 46 which has, for instance, four magnetic poles 32, having a pole pitch angle 50 of about 90°. Magnetic ring 46 is developed as a closed encircling ring, so that individual magnetic poles 32 seamlessly go over into one another. On rotor shaft 16, commutator 20 is situated, against which lie the same number of brushes 28 (for instance, four) as correspond to the number of magnetic poles 32. In the lower half of the illustration, the sinusoidal change in the number of conductor loops is shown again schematically, in the order of successively commutated coils 30. The number of conductor loops 36 per coil 30 varies, in this case, between 10 and 13, the change amounting to only a single conductor loop 36 per successively commutated coil 30. In this instance, a commutation phase extends over seven commutation states, which together form a period of sine curve 60. For this reason, an especially smooth sine curve 60 comes about for the change in the number of conductor loops. In this exemplary embodiment of four-pole machine 12, one therefore obtains the four-fold rotor rotational frequency for the frequency of the additional current ripple generated using the conductor loop variation. An oscillation having the magnetic pole order is impressed on the motor current curve, in this case. Such a current ripple frequency is clearly lower, in this context, than the corresponding slot frequency of the motor current signal. The sequence of successively commutated coils 30 according to sine curve 60 is not coincident, in this case, with the sequence of coils 30 with respect to the circumference of rotor 18.

In this exemplary embodiment, coils 30 are developed in each case as two symmetrical coil sections 29, which are situated geometrically parallel to each other as mirror images to an imaginary plane going through rotor axis 17. The two coil sections 29, in this context, are also connected electrically in parallel, and connected to respectively same commutator segments 22, so that the two coil sections 29 act together with respect to magnetic poles 32 of stator 34 as one single coil 30. This is shown, for example, at a specific coil 53, at which the first coil section 29 is wound between the first and the fourth slot 24, going clockwise, and second coil section 29 between the eighth and the eleventh slot 24. This coil 53, made up of two coil sections 29, has in each case thirteen conductor loops 36, for example. Coils 30 of rotor 18, that follow clockwise are made up respectively of 11, 10, 12, 12, 10, 11 conductor loops 36. In this exemplary embodiment, commutator 20 has fourteen commutator segments 22, which are connected to the seven coils 30, made up of altogether fourteen coil sections 29. In this context, after a commutation of seven successive coils 30, the same phase position of the commutation is reached again as the one at the outset, so that, in the case of fourteen commutator segments 22 and four brushes 28, four periods 38 come about over one rotor revolution.

To determine rotational speed data, the motor current signal flowing through brushes 28 and commutator 20 is evaluated with respect to its ripple, and from this a signal is obtained which represents the rotational speed and period duration of the rotor revolution. For this purpose, the motor current signal is supplied to an electronics unit 40 which has a jamming protection function 44. In order to determine, for example, whether a certain closing force is exceeded for a part that is to be moved by electric machine 12, the signal representing the rotational speed is investigated for its change. For this, the measured values having the frequency of the current ripple read in, are compared to one another, in order to detect a rotational speed decrease. In order to trigger the closing force limitation, the changing value of the signal representing the rotational speed is compared to a specifiable signal, for example, so that a certain threshold for a closing force or a spring rate may be set.

It should be noted that, with respect to exemplary embodiments shown in the figures and the description, multiple combinations are possible among the individual features. Thus, for instance, the number of magnetic poles 32 and of the commutator segments 22 may be varied. Because of that, the current ripple signal generated may be adjusted to the requirement of the rotational speed evaluation, the current ripple signal preferably having a lower frequency than the slot frequency. The number, positioning and development of magnetic poles 32, of coils 30 and of slots 24 may be adapted to the respective application, especially to the respective power requirement. Thus, electric machine 12 may also be developed as an external-rotor motor. The method of winding coils 30 may also be varied, and individual tooth windings may also be used, whose number of conductor loops is modulated according to the present invention. Electric machine 12 is preferably used for actuating drives in a motor vehicle, for instance, for adjusting seat components, window panes and covers, but is not limited to such applications.

1-12. (canceled)

13. An electric machine comprising:
electric coils;
a commutator;
an evaluating unit for ascertaining rotational speed data from a ripple of a motor current signal;
a stator; and
a rotor, slots being situated on the rotor, in which individual conductor loops of the electric coils are situated, which are contacted to commutator segments of the commutator and to the evaluating unit, a number of the individual conductor loops of the coils being set in such a way that a sequence of the number of the conductor loops in an order of commutation substantially represents a sine function.

14. The electric machine according to claim 13, wherein the electric machine is for motorically moving movable parts in a motor vehicle.

15. The electric machine according to claim 13, wherein the number of the conductor loops of two successively commutated coils differs by exactly one conductor loop.

16. The electric machine according to claim 13, wherein the rotor has exactly fourteen slots, and the stator has exactly four magnetic poles, which are situated on a closed, single-part magnetic ring.

17. The electric machine according to claim 13, wherein the commutator has a number of commutator segments, which is not a multiple of a number of magnetic poles.

18. The electric machine according to claim 13, wherein exactly as many brushes lie against the commutator as a number of magnetic poles that are situated on the stator.

19. The electric machine according to claim 13, wherein exactly one period having a minimum and a maximum is modeled by the sequence of the number of conductor loops over one commutation phase.

20. The electric machine according to claim 13, wherein an order of arrangement of the coils with respect to a commutation sequence differs from a sequence of a spatial arrangement of the coils over a circumference of the rotor.

21. The electric machine according to claim 13, wherein the number of the individual conductor loops per coil amounts to between eight and fifteen.

22. The electric machine according to claim 13, wherein the number of the individual conductor loops per coil amounts to between ten and thirteen.

23. The electric machine according to claim 13, wherein the coils are centrosymmetric with respect to an axis of rotation of rotor coil sections, which are connected to one another electrically in parallel or in series, and the centrosymmetric coil sections have the same number of conductor loops.

24. A method for operating an electronic machine, comprising:
selecting a change in a number of individual conductor loops of electric coils over a commutation sequence in such a way that harmonics of a ripple of a motor current signal are suppressed; and
generating a detectable frequency of the ripple that is lower than a slot frequency of amplitude changes based on slots between commutator segments.

25. The method according to claim 24, wherein the electronic machine includes actuating drives in a motor vehicle.

26. The method according to claim 24, wherein the detectable frequency of the ripple corresponds to a number of magnetic poles.

27. The method according to claim 24, wherein a signal representing a rotational speed or a periodic duration of a rotor revolution is supplied as rotational speed information to an evaluating unit, which, based on a change with time of the signal, detects a jamming of a movable part, and reverses or stops the electronic machine.

28. The method according to claim 27, further comprising comparing the change in the signal to a stored boundary value, so as to trigger a jamming protection function in response to exceeding or undershooting the boundary value.
